(19) United States
(12) Patent Application Publication
(10) Pub. No.: US 2008/0093762 A1
(43) Pub. Date: Apr. 24, 2008

(54) Device for making multi-color foam product and method for making the same

(76) Inventor: Min Hui Wang, Taichung City (TW)

Correspondence Address: PHILLIP LIU, 6980, WHITEOAK DR., RICHMOND, BC, V7EAZ9, US

(21) Appl. No.: 11/543,040

(22) Filed: Oct. 5, 2006

(51) Int. Cl. B29C 44/02

(52) U.S. Cl. 264/51; 425/559; 425/561

(57) ABSTRACT

A method for making foam products steps of preparing variety of foam materials with different colors, mixing the materials in a final tank, feeding the materials in a mold, heating the materials which are then foamed to form a product which is then removed from the mold and cooled. The method is proceeded by a device which includes first tanks for receiving the variety of foam materials, second tanks for being fed with pre-set amount of the variety of foam materials, and a final tank which has mixture of the variety of foam materials. The mixture is then sent to a mold to be heated and foamed.

### FIELD OF THE INVENTION

The present invention relates to a device for making multi-color foam product and a method for making the same.

### BACKGROUND OF THE INVENTION

A conventional method for making a foam product such as a shoe generally uses a foaming material which has a fixed color and the foaming material is then made by way of ejection molding to form a shoe. However, due to restriction of the foam material, only one color can be added to the material and the single color products cannot meet requirements in the market. Therefore, the second color is painted on the product manually. The second color takes a lot of time to be painted on the shoe and is easily faded away by friction or being exposed in sunshine for a period of time.

### SUMMARY OF THE INVENTION

The present invention relates to a method for making foam products, and the method comprises a step of preparing materials, a step of mixing materials, a step of feeding materials in mold, a step of heating materials, a step of removing material from the mold, and a step of cooling.

A device for making foam products of the present invention comprises at least two first tanks for receiving foam materials of different colors and the materials are then fed into the second tanks at pre-set amount. The foam materials in the second tanks are sent into the final tank and a driving member rotatably extends into the final tank to mix the materials in the final tank and to eject the mixed materials into a mold.

The primary object of the present invention is to provide a device for making a product made by foam material with multiple colors and the product is made within one ejection molding process.

The second object of the present invention is to provide a method for making a product made by foam material with multiple colors.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the arrangement of the tanks of the device of the present invention;

FIG. 2 shows a perspective view of the device of the present invention;

FIG. 3 shows the driving member and the final tank of the device of the present invention;

FIG. 4 shows a side view of the driving member and the final tank of the device of the present invention;

FIGS. 5 to 9 shows different products made by the method and the device of the present invention, and

FIG. 10 shows the steps of the method of the present invention.

### DETAILED DESCRIPTION OF THE PREFERRED EMBODIMENT

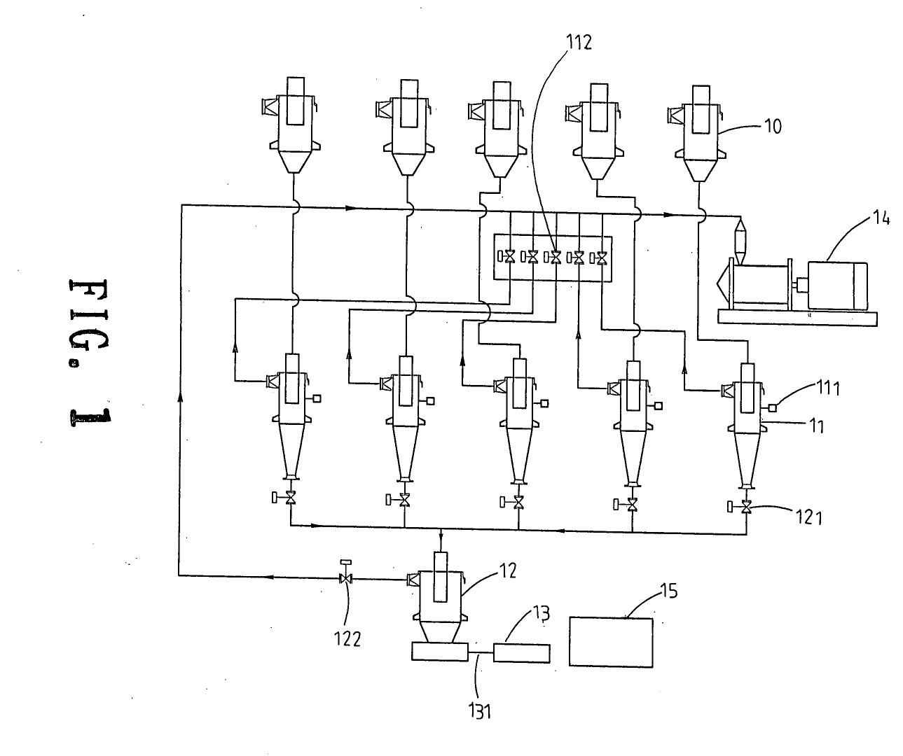

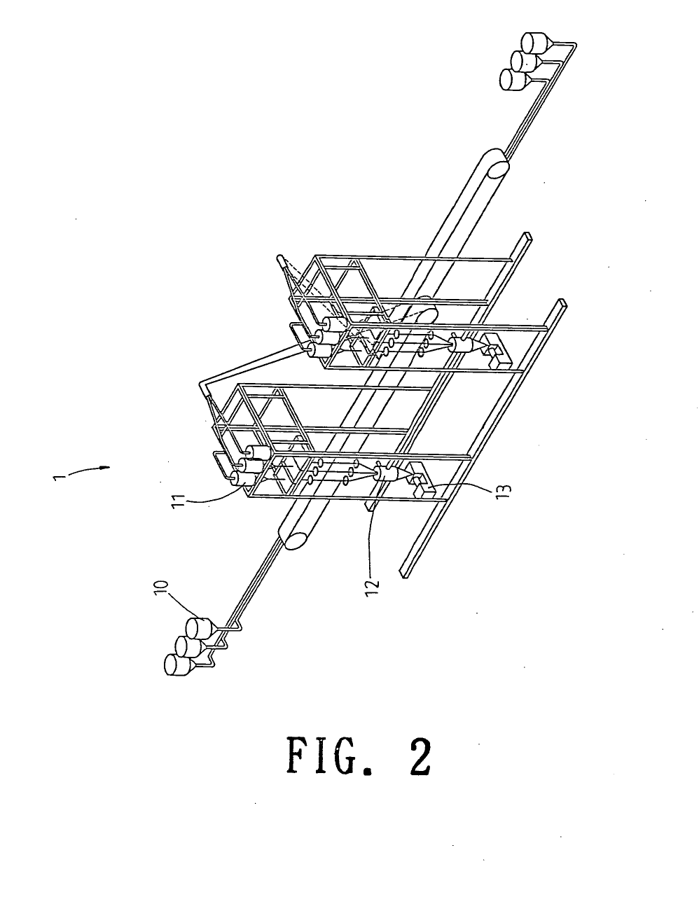

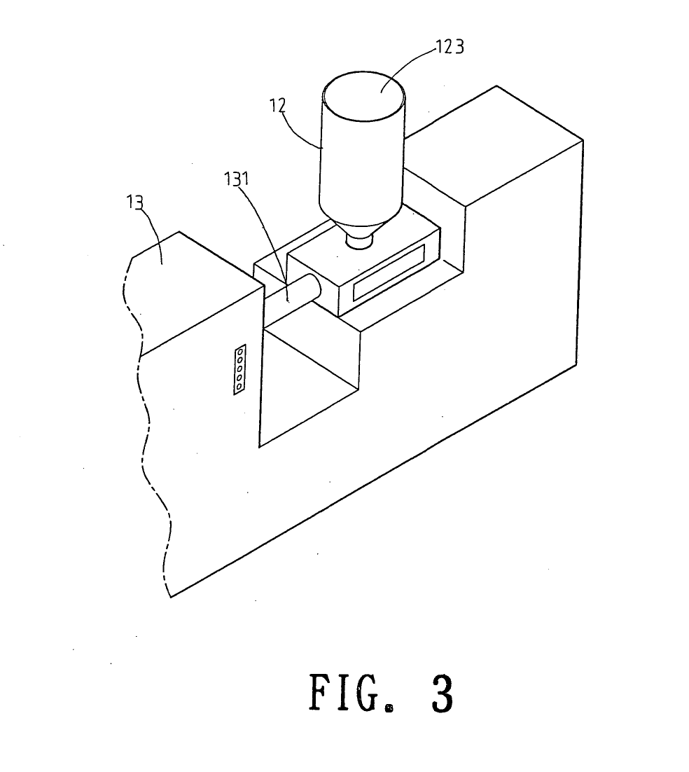

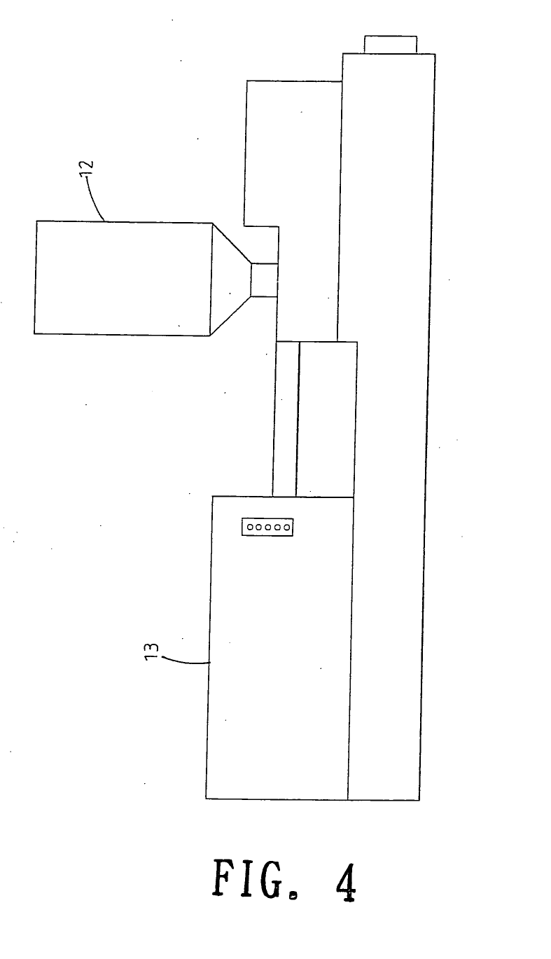

Referring to FIGS. 1 to 4, the device 1 for making multi-color foam product of the present invention comprises a plurality of first tanks 10 in which foam materials of different colors are received. A plurality of second tanks 11 are equipped so that the foam materials of the first tanks 10 are fed into the second tanks 11 at pre-set amount. A vacuum pump 14 is connected with the second tanks 11 so as to suck the foam material from the first tanks 10 into the second tanks 11. Each of the second tanks 11 has a control unit 111 cooperated with a vacuum valve 112, the control units 111 control the amount of foam material entering the second tanks 11 from the first tanks 10.

A final tank 12 and a second vacuum valve 122 is connected to the pipe between the final tank 12 and the vacuum pimp 14 so as to control the vacuum in the final tank 12. Each second tank 11 further is connected with a third vacuum valve 121 which controls the amount of the foam material in the second tank 11 to be sent to the final tank 12. A driving member 13 has a threaded driving rod 131 which rotatably extends into the final tank 12 to mix the materials in the final tank 12 and to eject the mixed materials into a mold 15. The following steps such as heating the foam materials in the mold and removal of the foam materials from the mold 15 are well known in the art and will not be described.

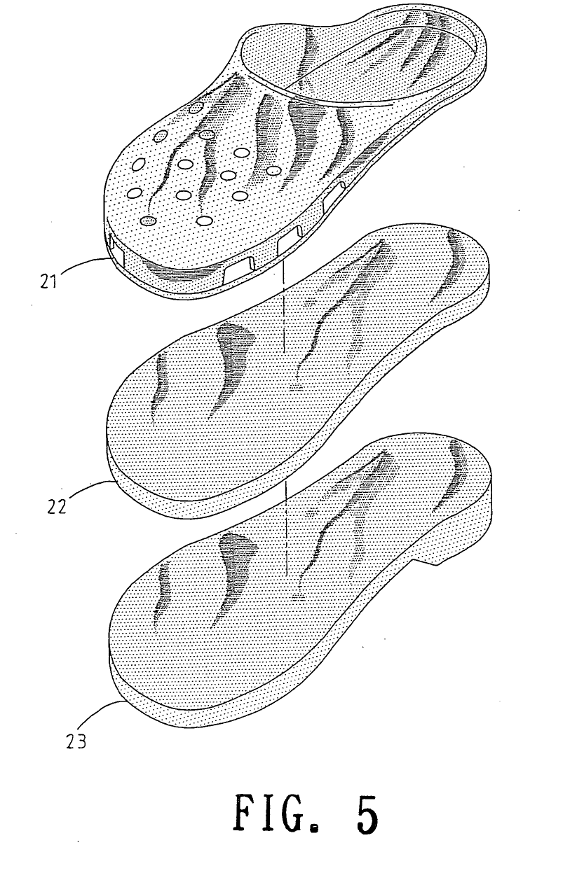

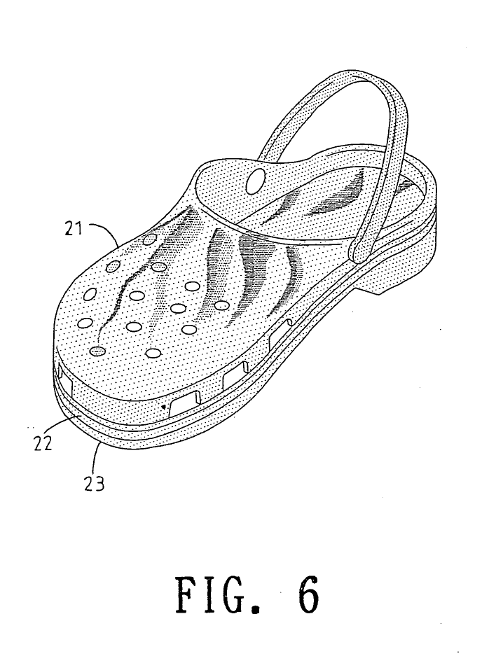

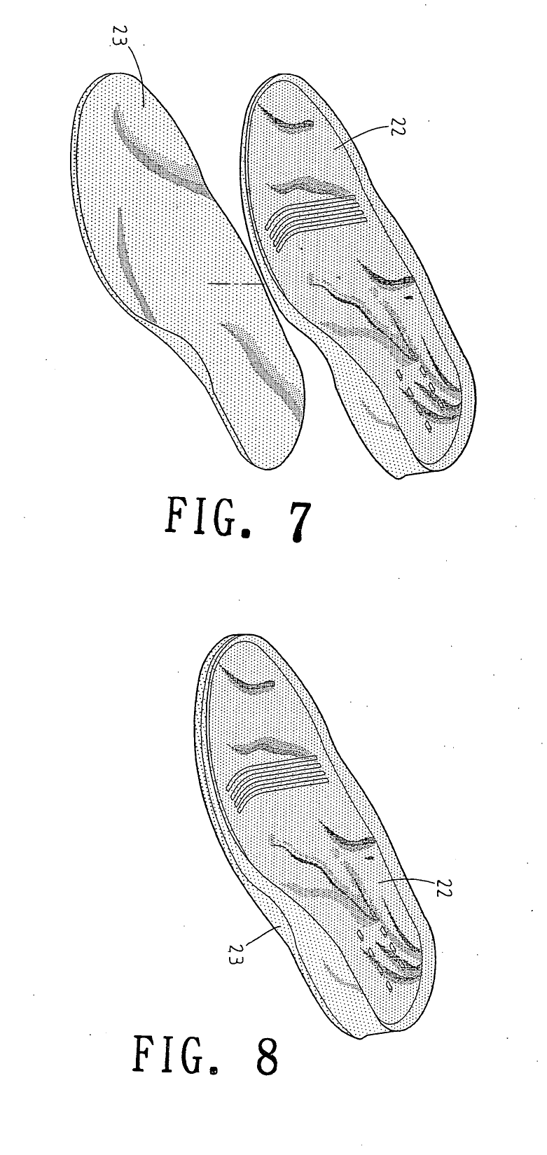

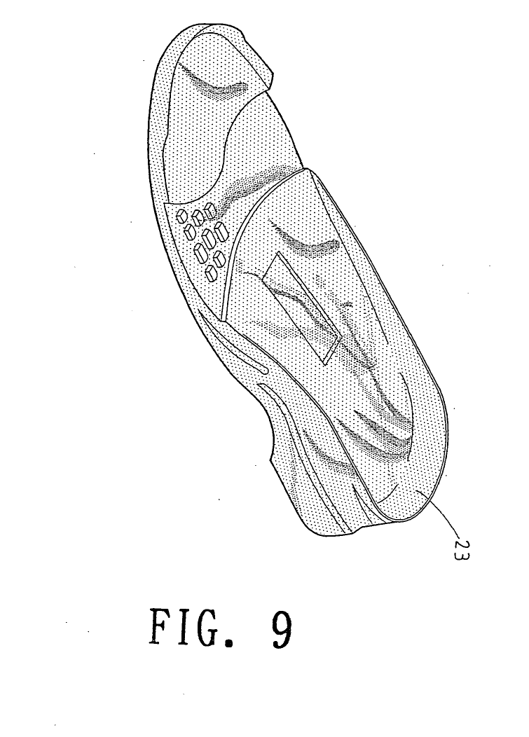

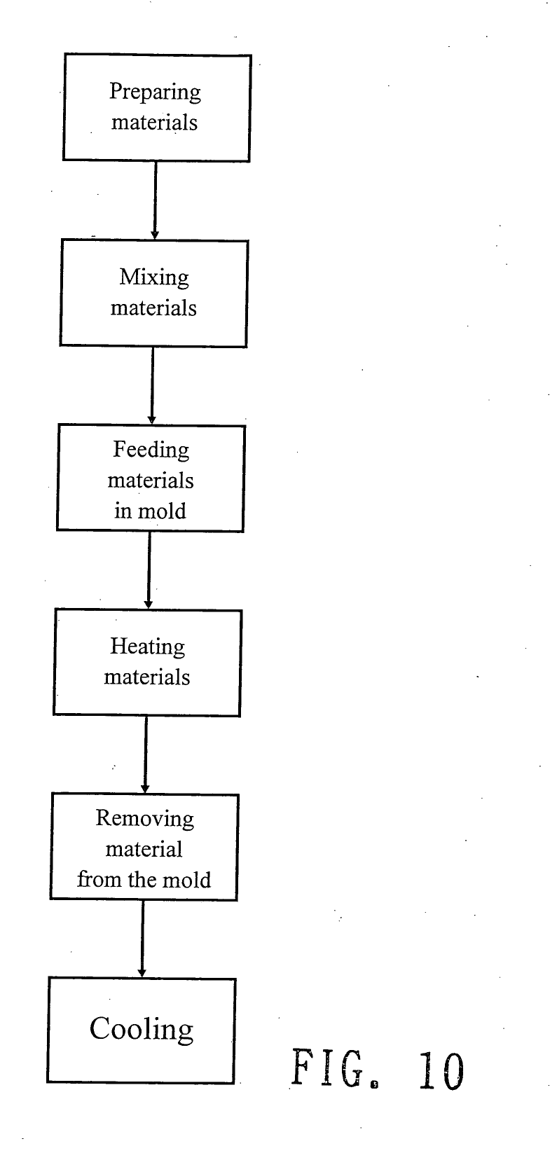

The final products made by the device 1 of the present invention can be a shoe comprising a vamp 21, a middle sole 22 and an outsole 23, a vamp 21 of a shoe and/or a middle sole 22 of a shoe as shown in FIGS. 5 to 9.

The method for making foam products of the present invention comprises the following steps:

a step of preparing materials: preparing variety of foam materials with different colors;

a step of mixing materials: mixing the materials in a final tank 12;

a step of feeding materials in mold: using a driving member 13 to feed the materials in a mold 15;

a step of heating materials: heating the mold and the materials in the mold 15, the materials being foamed;

a step of removing material from the mold: removing the foamed materials from the mold 15, and a step of cooling: cooling the foamed material.

It is noted that the step of cooling can be proceeded in a gradually cooled heating oven or in room temperature.

While we have shown and described the embodiment in accordance with the present invention, it should be clear to those skilled in the art that further embodiments may be made without departing from the scope of the present invention.

What is claimed is:

1. A method for making foam products, comprising:
a step of preparing materials: preparing variety of foam materials with different colors;
a step of mixing materials: mixing the materials in a final tank;
a step of feeding materials in mold: using a driving member to feed the materials in a mold;
a step of heating materials: heating the mold and the materials in the mold, the materials being foamed;
a step of removing material from the mold: removing the foamed materials from the mold, and
a step of cooling: cooling the foamed material.

2. The method as claimed in claim 1, wherein the foamed material is a shoe comprising a vamp and an outsole.

3. The method as claimed in claim 1, wherein the foamed material is a vamp of a shoe

4. The method as claimed in claim 1, wherein the foamed material is a middle sole of a shoe.

5. The method as claimed in claim 1, wherein the foamed material is an outsole of a shoe.

6. The method as claimed in claim 1, wherein the step of cooling is proceeded in a gradually cooled heating oven.

7. The method as claimed in claim 1, wherein the step of cooling is proceeded in room temperature.

8. A device for making foam products, comprising:
at least two first tanks in which foam material of different colors are received;
a plurality of second tanks and the foam materials of the at least two first tanks being fed into the second tanks at pre-set amount;
a final tank and the foam materials in the second tanks being sent into the final tank, and
a driving member having a driving rod which rotatably extends into the final tank to mix the materials in the final tank and to eject the mixed materials into a mold.

9. The device as claimed in claim 8, wherein a vacuum pump is connected with the second tanks and the final tank so as to suck the foam material from the at least two first tanks into the second tanks and to suck the foam material from the second tanks into the final tank.

10. The device as claimed in claim 8, wherein each of the second tanks has a control unit which controls the amount of foam material entering the second tanks from the first tanks.
